(19) United States
(12) Patent Application Publication
(10) Pub. No.: US 2024/0367596 A1
(43) Pub. Date: Nov. 7, 2024

(54) Scale Model Wiring Harness for Combustion Engine

(71) Applicant: Edward D Nunn, Woodbury, MN (US)

(72) Inventor: Edward D Nunn, Woodbury, MN (US)

(21) Appl. No.: 18/653,690

(22) Filed: May 2, 2024

Related U.S. Application Data
(60) Provisional application No. 63/499,592, filed on May 2, 2023.

(51) Int. Cl. B60R 16/02; B60R 16/023; B60R 16/03; H01B 7/00

(52) U.S. Cl. CPC B60R 16/0207; B60R 16/023; B60R 16/03; H01B 7/0045

(57) ABSTRACT

A wiring harness for a scale fuel burning model car that utilizes a multi-voltage battery system having the capacity to direct, control and relay electrical power to any number of a fuel burning vehicle's means of propulsion, acceleration, control (i.e., steering), cooling and/or lighting. Specifically, the present body wiring harness is designed to start a V8 fuel burning engine with a 12-volt starter motor and then control and power various components including, but not limited to, an air conditioning (“a/c”) fan, vehicle steering, vehicle braking, vehicle throttle and flip bucket light servos, radio control receiver(s), as well as several illuminable lights (e.g., parking lights, brake lights, headlights, interior dome and dash cluster lights), as well as certain ignition system modes of interchangeable function(s).

### REFERENCE TO RELATED PATENTS

The present application claims priority to the previously filed provisional application No. 63/499,592 filed May 2, 2023

### FIELD OF THE INVENTION

The present invention relates to a wiring harness for a scale fuel burning model car that utilizes a multi-voltage battery system. Generally, the wiring harness has the capacity to control and relay any number of a fuel burning vehicle's means of propulsion, acceleration, control (i.e., steering), cooling and/or lighting. In particular, the present invention is designed to start a V8 fuel burning engine with a 12-volt starter motor, control and power various components including: an air conditioning (“a/c”) fan, vehicle steering, vehicle braking, vehicle throttle and flip bucket light servos, radio control receiver(s), as well as several illuminable lights (e.g., parking lights, brake lights, headlights, interior dome and dash cluster lights), as well as certain ignition system modes of interchangeable function(s).

### BACKGROUND

Scale (ex. ⅓rd, ¼, ⅕th) model cars and vehicles with fuel burning engines are popular among hobbyists and enthusiasts who enjoy building, operating and racing miniature replicas of actual (full-scale) vehicles. These models typically rely on fuel engines and battery-power for motors and servos to control their acceleration, deceleration, movement, lights and other functions.

The use of multiple voltage batteries can present a challenge in creating an efficient wiring system that can control and power the various components of the model from ignition (via “glow engines”) to control, to propulsion, direction and lighting. A certain array of various and varied harnesses exists to control the many functions of fuel burning (“glow”) engines but no comprehensive wiring harnesses has been developed, connecting the various components for scale fuel burning models, and none are readily available in today's market. This results in one-off, DIY and/or cumbersome solutions for scale model building enthusiasts to both power and control their vehicles.

It is the objective of the present invention to remedy these deficiencies in the art and to allow scale model vehicle hobbyist, motorists, and enthusiasts the ability to seamlessly integrate assorted critical functionalities into a single, ergonomic and comprehensive wiring harness device.

As a basis, current technology consistent with historically understood conventional internal combustion engine operations, unlike scale model glow engines, combine fuel combustion (through a spark plug firing) with an oxidizer (e.g., oxygen in air) within a combustion chamber utilizing the resultant expansion created by high temperature, high pressure gases to produce combustion to create motive force via piston movement attached to a rotating crankshaft. The crankshaft is in turn tied to a connecting rod and then a crankshaft. As the pistons “fire” a downward force is created, moving through a connecting rod, and to an attached crankshaft. The crankshaft then takes the reciprocating motion created in the pistons and turns that force into a rotational (motive) force and, ultimately a rotational motion for vehicle propulsion.

Alternatively, glow engines use the “glow plug” only for starting the engine where the catalytic effect of a platinum wire is controlled by a helical wire filament within a plug's tip. When an electric current is placed through the plug, or when exposed to the heat of a combustion chamber, the filament itself glows which in turn ignites the nitromethane fuel. Power to the heating element may be supplied by any one of a number of batteries.

While propulsion may be produced in largely the same manner, the means for achieving propulsion and, more importantly maintaining propulsion, are quite different.

Too, fuel for these engines typically contains an alcohol, methanol fuel, as opposed to a petroleum-based mixture of hydrocarbons, with varying percentages of nitromethane acting as the oxidizer, most commonly ranging from 5% to 30% based on use and intended purpose. This fuel is further suspended in an oil base acting as a lubricant and heat regulator which is ultimately released as exhaust.

Pointedly, starting the scale nitromethane engine requires first a power source (e.g., a high current, single cell DC battery generating around 3 amps and 1.5 volts or a 12 VDC panel) applied directly to the plug from a glow plug igniter. The generated current heats a platinum filament, causing a red-hot glow (thus the “glow plug”), whereby the fuel is then introduced to the combustion chamber. And, unlike larger internal combustion engines, once the engine is running, the electrical “spark” is no longer required and can be ceased. Each subsequent combustion keeps the glow plug filament hot, which along with the catalysis of methanol oxidation by the platinum, allows the ignition of the next charge in a self-sustaining power cycle so long as fuel is supplied and the engine continues to run.

As well, where timing is not controlled by fuel delivery (injection) as it would be in a diesel engine, or electrically as in a spark ignition engine, timing must be adjusted by changing fuel/air mixture and plug/coil design through adjusting the shape and configuration of inlets and adjusting controls on the engine itself where a richer mixture will cool the filament and so slow ignition (and engine speed) and a leaner mixture produces more power, albeit with less lubrication, which can result in greater speed at the expense of overheating and detonation.

And while a battery-operated energy source is critical to initiating glow plug activation, it is also integral to several other functions within a model vehicle. In fact, battery power is used additionally to control functional movement (motive, anti-motive and directional operations) of a scale combustion engine vehicle as well as more esthetic utilities including interior lighting, exterior lighting or a combination thereof.

It is therefore a long-sought and unmet need in the field of scale combustion engines to address the many requirements of a functioning and functional remotely controlled vehicle through a single wiring (body) harness capable of directing and controlling several voltages across multiple pathways and distances to service each discrete operation in a scale vehicle.

In order to address this issue, inventor has developed a wiring (body) harness for a scale combustion engine for scale model vehicles that seamlessly connects various voltage requiring components, as described herein, for increased functionality and flexibility of control which utilizes multiple batteries with various voltages to power starter motors, throttles, fans, servos, receivers, lights, and other components.

### SUMMARY

Embodiments described herein comprise a scale model vehicle harness for a nitromethane combustion engine integrating a charger lead for use in a lead starter battery whereby said harness incorporates a ‘Y’ harness standard reverser for positional servo adjustment of bucket headlights, throttle, and brake servos. Yet, it should be noted that a scale combustion engine, regardless of fuel sourced, will equally benefit from this same design and multi-nodal harness configuration.

This same harness also connects the glow driver to both the throttle and brake servo, through a splitter connector, allowing the glow driver's glow plug heating engagement to be operated independently, in conjunction with throttle servo position or a modifiable combination of the two. This allows the mechanical endpoints of both servos and electronic endpoints of the glow plug driver to be adjusted independently of each other for the best throttle and brake control and response with a mechanical carburetor and electronic glow plug engagement.

### BRIEF DESCRIPTION OF THE DRAWINGS

While the novel features and method of use of the invention are set forth above, the application itself, as well as the preferred mode of use and present embodiments, may be best understood, and numerous objects, features, and advantages made apparent to those skilled in the art when read in conjunction with and by referencing the accompanying drawings in view of the appended claims, wherein:

FIG. 1 shows a representation of a body harness.

FIG. 2 depicts the schematic of a body harness within a vehicle.

FIG. 3 is a removed body harness.

FIG. 4 shows an ignition harness.

FIG. 5 is a diagrammatic rendering of a body harness.

FIG. 6 is a body harness applied to a scale vehicle.

FIG. 7 is a representative diagram of a body harness.

And, although the present invention, system and method of use are amendable to various modifications and alternative configurations, specific embodiments thereof have been offered by way of example in the drawings and are herein described in adequate detail to teach those having skill in the art how to make and practice the same.

It should, however, be understood that the above description and preferred embodiments disclosed, are not intended to limit the invention to one particular embodiment or embodiments disclosed, but, on the contrary, the invention disclosure is intended to cover all modifications, alternatives and equivalents falling within the spirit and scope of the invention as defined within the claim's broadest reasonable interpretation consistent with the specification.

### DESCRIPTION OF EMBODIMENT(S)

The description that follows includes exemplary apparatuses, methods, techniques, and instructional sequences that embody representative features and configurations, preferred embodiments and the best mode known to inventor of practicing the present inventive subject matter. Yet, it is to be understood that the disclosed embodiments are merely illustrative whereby elements and materials may be substituted for those illustrated and herein described, parts and processes may be rearranged, and certain features of the apparatuses, systems and methods may be utilized independently, in conjunction, in connection, in an ordered configuration or reconfigured-all of which would be apparent, is in the contemplation of inventor and being within the contemplation of those persons having ordinary skill in the art having the additional benefit of this present disclosure.

The present invention provides for flawless integration of various voltage batteries, required in the many voltage requirements of a scale model, combustion driven vehicle, into a single wiring harness wherein several components may be serviced across the entirety of a vehicle. The present invention allows for a distribution of power to starter motors, operational motors, receivers, a/c fans, servos, and internal and external lighting—each requiring disparate voltages, combinable across a single wiring harness to connect the various components for achieving the most efficient operation of scale fuel burning models in terms of locomotion and peak operation.

The present invention combines and integrates a charger lead for a lead starter battery wherein a harness utilizes a ‘Y’ harness standard reverser for positional servo adjustment of bucket headlights, throttle and brake servos. The same harness also connects the glow driver to both the throttle and brake servo, through a splitter connector, to allow a glow driver glow plug heating engagement independently or in conjunction with throttle servo position. As an alternative, this functionality may be variable and modifiable as necessity and requirements dictate as to achieve the most efficient operations. This allows the mechanical endpoints of both servos and electronic endpoints of the glow plug driver to be adjusted independently of each other for best throttle and brake control and the most efficient responses with mechanical carburetors and electronic glow plug engagements.

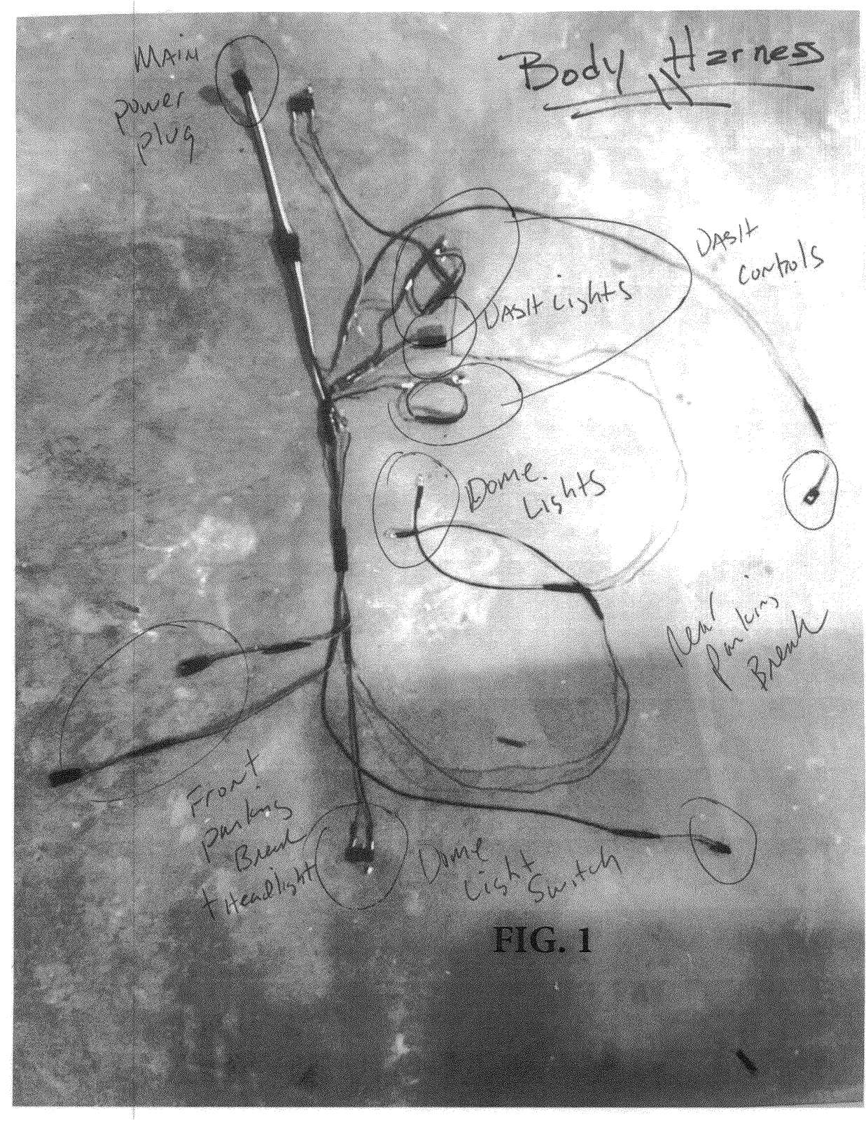

Turning to FIG. 1, is one embodiment of a body harness where can be seen several flexible multi-conductor cables adapted to connect various component functions and supplementary chassis harness. This is significant because it allows both chassis and body component functions to work in concert across the chassis and body for unified model control, i.e. when the chassis located brake servo is engaged, the corresponding brake light in the body are activated.

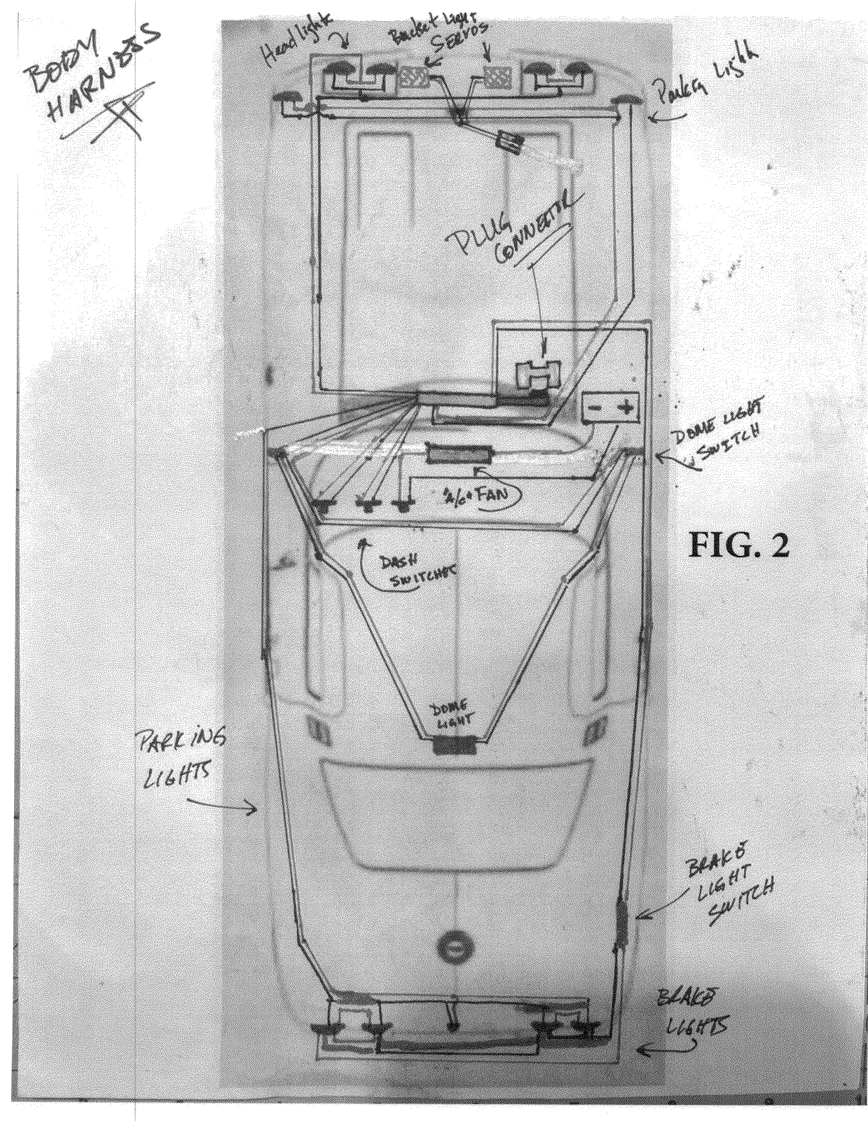

FIG. 2 shows a diagrammatic of the present invention installed into a scale model vehicle wherein utilization of components and supplementary harness connectivity for internal and external electrical devices including servos, receiver, lights & starter motor allow integration of desired functional scale control of the model. In this example the result is the dash controls activate manually the parking lights, front headlights, A/C fan and starter motor in the scale environment.

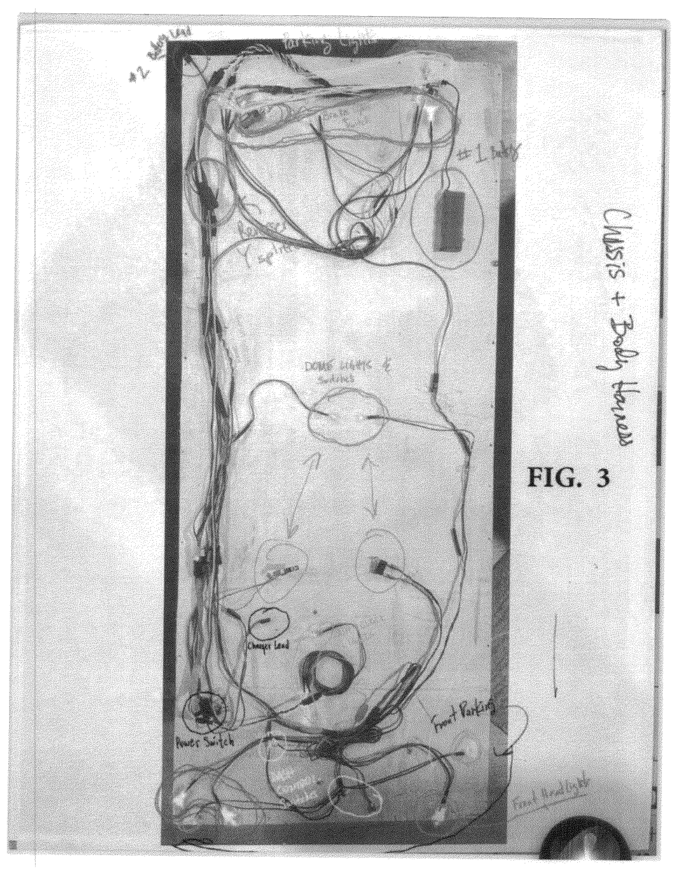

As can be seen in FIG. 3, a body harness is depicted wherein both the chassis and body are connected to power all the model's lights via activation initiated on either the chassis or body. Specifically, the interior doors activate the interior cabin's dome lights via switches on the door hinges (circled in green), the brake lights are activated via a chassis mounted servo and switch (circled in blue) and the parking, front and dash lights activated manually via switches on the interior dash cluster gauge. The multifunctional interior and exterior scale lighting for the model is indicative of a the level of intricate control the harness allows.

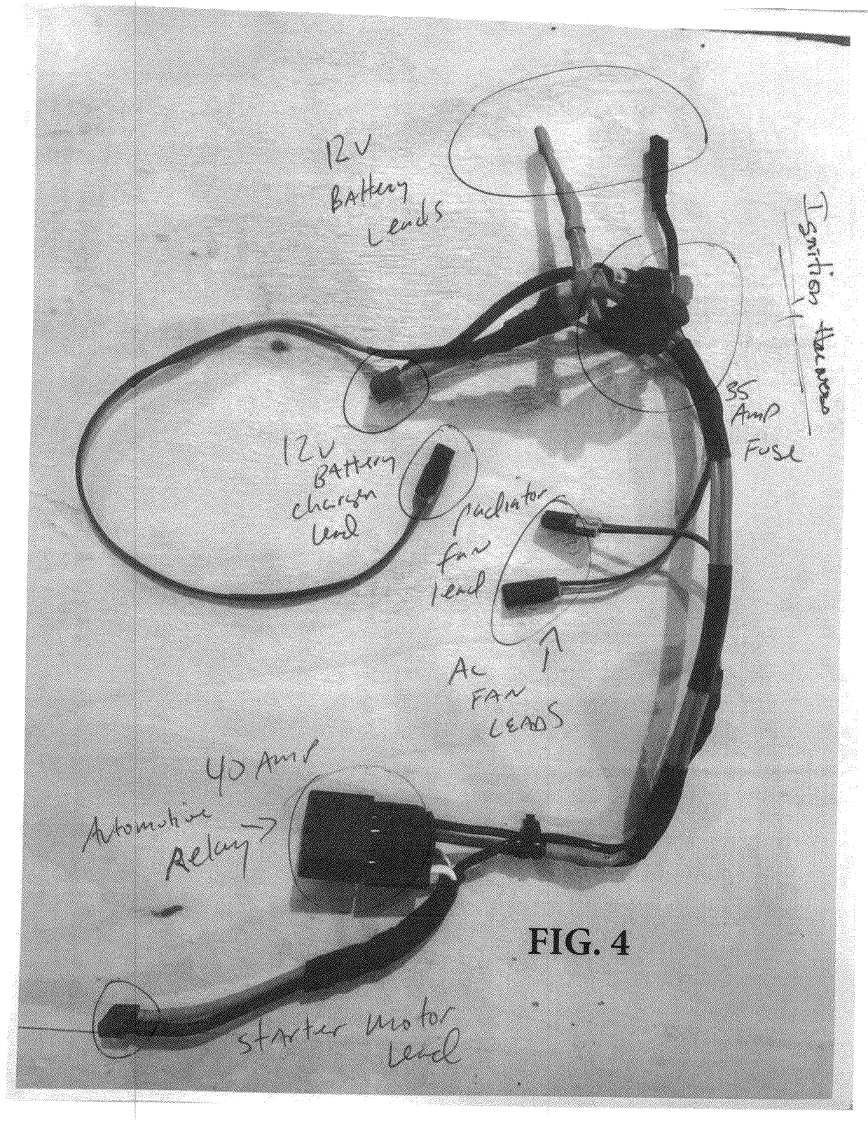

Too an ignition harness is shown in FIG. 4 where fused power is provided for the model's various functions that require 12 volts.

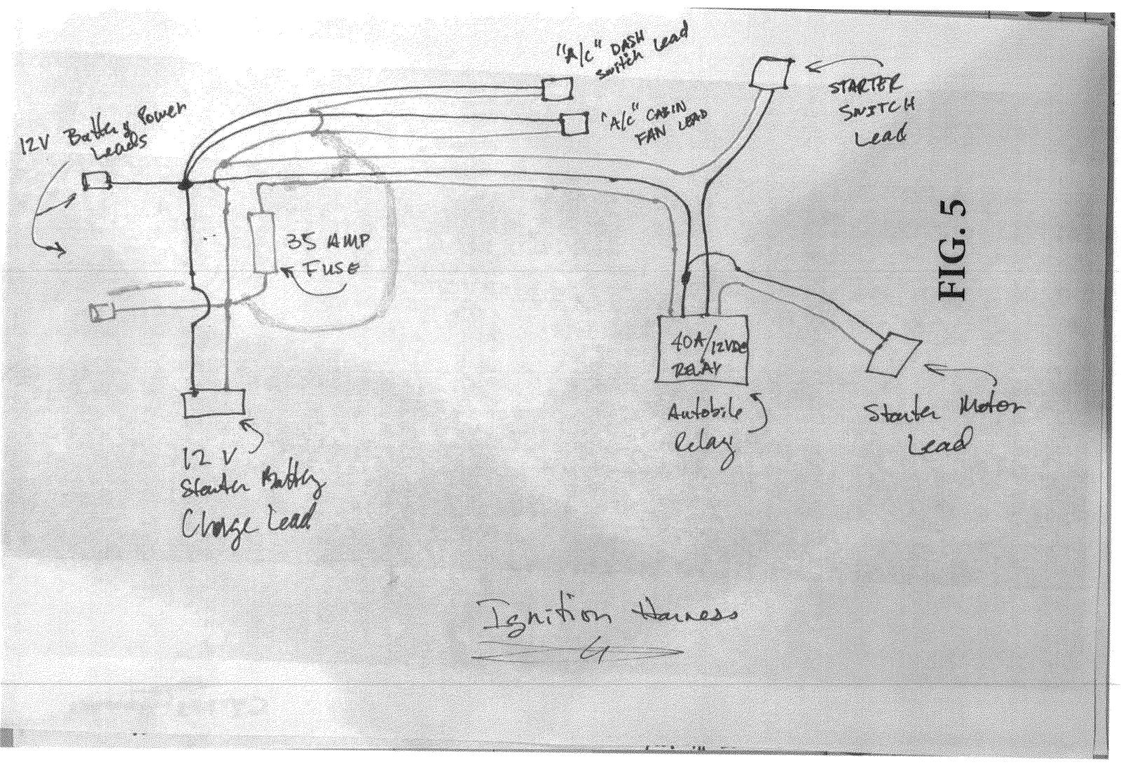

Further to the photographic representation in FIG. 4, FIG. 5 shows, as labeled, a configuration whereby a 35 amp fuse is incorporated into the harness to power the interior cabin “A/C” fan and switch, starter motor and keyed switch with an integrated 40 Amp/12V automotive relay switch and charging lead for a 12 V lead battery. Wherein previous harnesses are for 6V power needs, as can be seen, FIG. 5 illustrates the ability to power 12V needs.

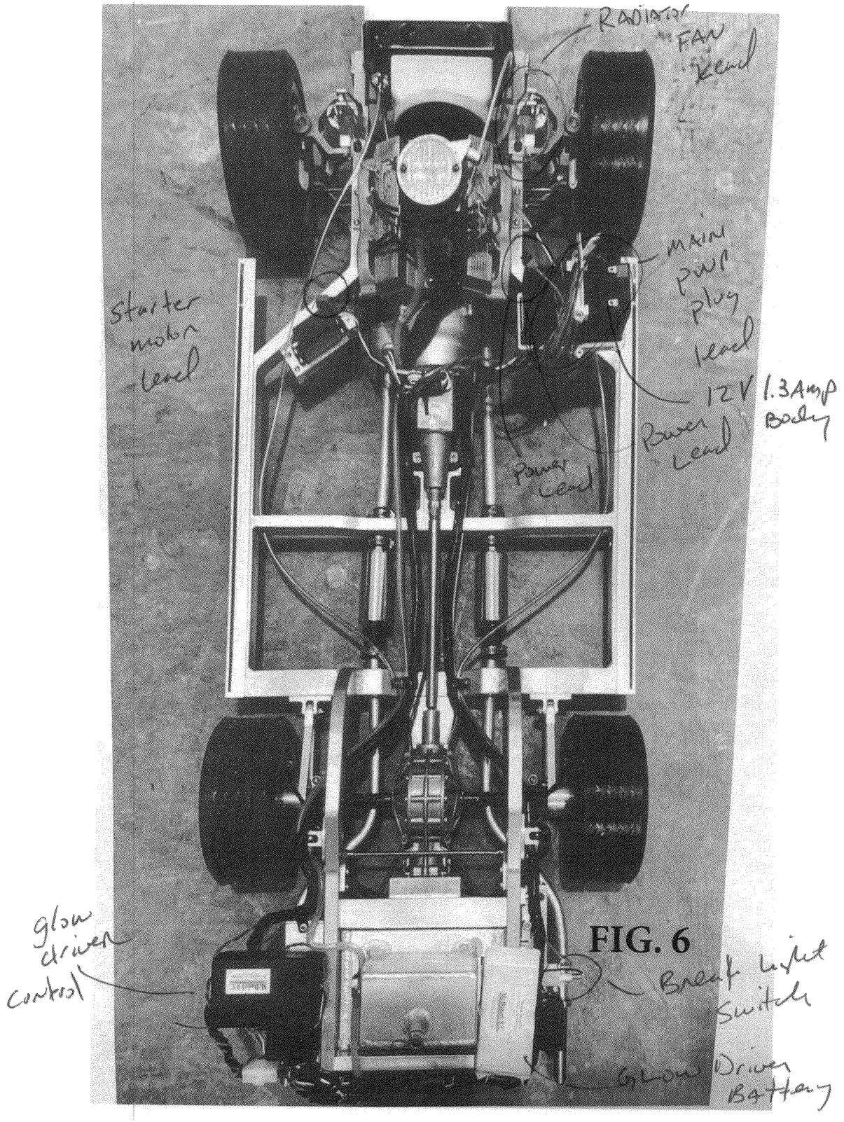

FIG. 6 photographically represents the connection of the glow driver into the harness.

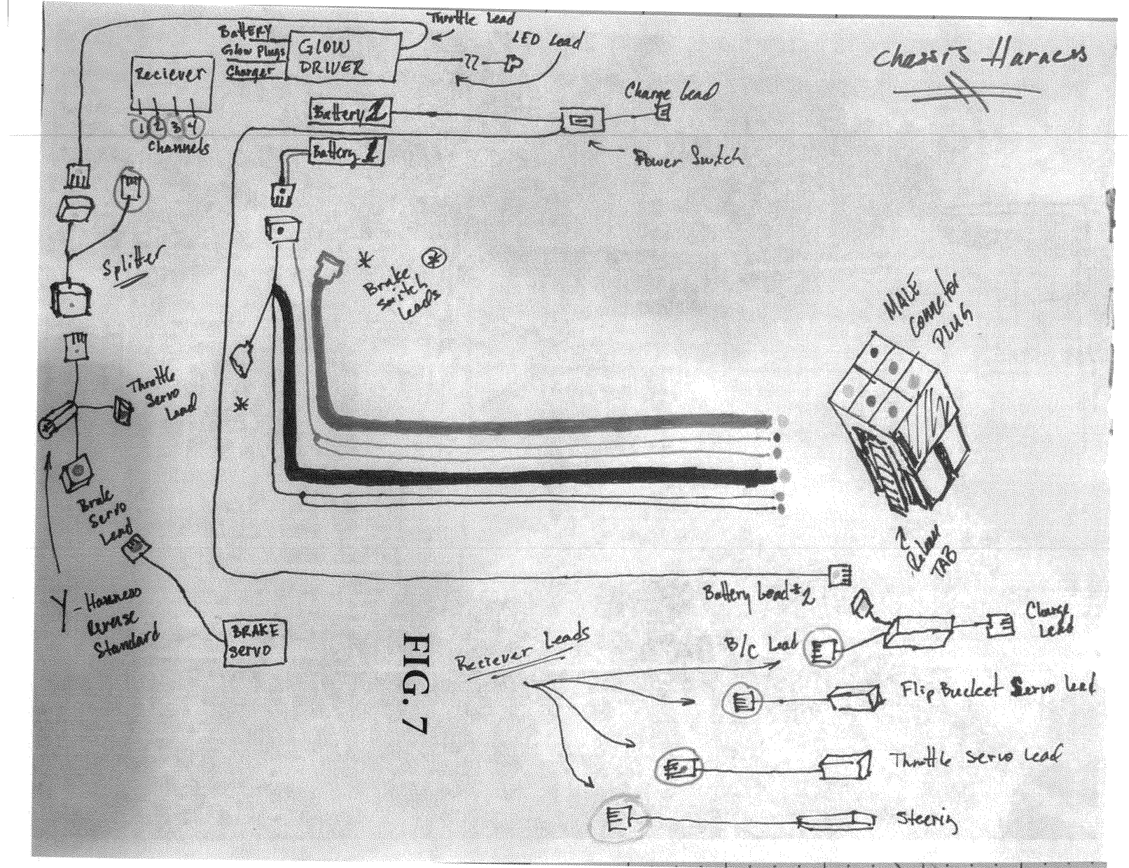

FIG. 7 diagrammatically details the chassis harnesses' integration of the 4.8V powered glow plug driver function (section 0028) with the 6V powered brake, throttle, steering and bucket headlight servos and receiver functions. This integrated configuration connects chassis located functions to the body located functions via the male connector plug. This configuration is critical because it allows the desperately powered systems to work in concert to both power and control the model in all needed and wanted ways.

In a preferred embodiment, the present invention comprises a wiring harness for a combustion engine-controlled scale model vehicle that comprises a multi-voltage battery, various gauge wire harness and wiring system for control and power supply delivery, in a single harness, configured in a manner to seamlessly control and relay electrical power to a plurality of the vehicle's components, thereby servicing across the entirety of the vehicle. In another preferred embodiment, the plurality of batteries in the harness comprise combinations of voltages based on the component that the battery power is controlling. Examples of battery voltages in such a harness include but are not limited to 6 volts, 4.8 volts, 12 volts or a combination thereof.

In yet another preferred embodiment, various wire gauges are utilized, interchangeably, based on battery voltage, power supply distance and serviced component, or a combination thereof, commensurate with battery voltage, power supply distance and serviced component. In another preferred embodiment, the harness includes but is not limited to a charger lead, Y harness standard reverser, a splitter connector, or a combination thereof.

In another preferred embodiment, the Y harness standard reverser is incorporated in the harness for positional servo adjustment of bucket headlights, throttle, brake servos, or a combination thereof. In yet another preferred embodiment, the splitter connector is incorporated in the harness to connect the glow plug driver to throttle and brake servo to enable heating of glow plug by the glow plug driver independently or in combination with the throttle position. Examples of functions powered by the harness include but are not limited to light system, servos, radio, glow plug driver, A/C fan, brakes, parking lights, front headlights, starter motor, or a combination thereof.

In another preferred embodiment, the harness connects internal and external devices comprising servos, receiver, lights and starter motor to allow dash controls to manually activate parking lights, front headlights, A/C fan, starter motor or a combination thereof. In yet another embodiment, the harness connects chassis and body to initiate activation of the vehicle's lights on either the chassis or the body. In further yet another embodiment, the harness comprises a 35 amp fuse to power the interior cabin A/C fan and switch, starter motor and keyed switch, and a 12V automotive relay switch and charging lead for 12V lead battery.

In still yet another embodiment, the harness connects chassis located functions to body located functions via a male connector plug, where the configuration integrates 4.8V powered glow plug driver function with 6V powered brake, throttle, steering, and bucket headlight servos and receiver functions. Examples of vehicles powered by the harness include but are not limited to the ones that have gas engine or nitromethane engine. In another embodiment, the vehicle's components are serviceable based on power supply voltage and current rating requirements and where the harness is configurable based on selection of components by a user. In yet another embodiment, the harness is configurable and reconfigurable based on the component selections and power delivery requirements.

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, diagrammatical and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments of the invention, which are defined only by the appended claim(s). Each of the embodiments described herein are contemplated as falling within the inventive subject matter, which is set forth in the below.

Plural instances may be provided for components, operations or structures described herein as a single instance. In general, structures and functionality presented as separate components in the exemplary configurations may be implemented as an integrated or combined structure, combined structures, component or series of components. Similarly, structures and functionality presented as a single component may be implemented as separate components or cumulatively as a group of components or as a system. These and other variations, modifications, additions, and improvements all fall within the scope of the inventive subject matter.

What is claimed is:

1. A wiring harness for a combustion engine-controlled scale model vehicle, comprising:
a multi-voltage battery, various gauge wire harness and wiring system for control and power supply delivery, in a single harness, configured in a manner to seamlessly control and relay electrical power to a plurality of the vehicle's components, thereby servicing across the entirety of the vehicle.

2. The wiring harness of claim 1, wherein the plurality of batteries in the harness comprise combinations of voltages based on the component that the battery power is controlling.

3. The wiring harness of claim 2, wherein said battery voltage is 6 volts, 4.8 volts, 12 volts or a combination thereof.

4. The wiring harness of claim 3, wherein various wire gauges are utilized, interchangeably, based on battery voltage, power supply distance and serviced component, or a combination thereof, commensurate with battery voltage, power supply distance and serviced component.

5. The wiring harness of claim 1, wherein said harness comprises a charger lead, Y harness standard reverser, a splitter connector, or a combination thereof.

6. The wiring harness of claim 5, wherein said Y harness standard reverser is incorporated in the harness for positional servo adjustment of bucket headlights, throttle, brake servos, or a combination thereof.

7. The wiring harness of claim 5, wherein said splitter connector is incorporated in the harness to connect the glow plug driver to throttle and brake servo to enable heating of glow plug by the glow plug driver independently or in combination with the throttle position.

8. The wiring harness of claim 1, wherein said harness powers light system, servos, radio, glow plug driver, A/C fan, brakes, parking lights, front headlights, starter motor, or a combination thereof.

9. The wiring harness of claim 1, wherein the harness connects internal and external devices comprising servos, receiver, lights and starter motor to allow dash controls to manually activate parking lights, front headlights, A/C fan, starter motor or a combination thereof.

10. The wiring harness of claim 1, wherein the harness connects chassis and body to initiate activation of the vehicle's lights on either the chassis or the body.

11. The wiring harness of claim 1, wherein said harness comprises a 35 amp fuse to power the interior cabin A/C fan and switch, starter motor and keyed switch, and a 12V automotive relay switch and charging lead for 12V lead battery.

12. The wiring harness of claim 1, wherein said harness connects chassis located functions to body located functions via a male connector plug, wherein said configuration integrates 4.8V powered glow plug driver function with 6V powered brake, throttle, steering, and bucket headlight servos and receiver functions.

13. The wiring harness of claim 1, wherein the vehicle has gas engine or nitromethane engine.

14. The wiring harness of claim 1, wherein said vehicle's components are serviceable based on power supply voltage and current rating requirements and wherein said harness is configurable based on selection of components by a user.

15. The wiring harness of claim 14 wherein said harness is configurable and reconfigurable based on said component selections and power delivery requirements.
